(19) United States
(12) Patent Application Publication
(10) Pub. No.: US 2009/0173454 A1
(43) Pub. Date: Jul. 9, 2009

(54) Double-layer window covering and transverse moving apparatus thereof

(76) Inventor: Li-Ming Cheng, Kaohsiung City (TW)

Correspondence Address: Frenkel & Associates, P.C.;Suite 300, 3975 University Drive, Fairfax, VA, 22030, US

(21) Appl. No.: 12/008,172

(22) Filed: Jan. 9, 2008

(51) Int. Cl. E06B 9/56; E06B 9/08

(52) U.S. Cl. 160/120; 160/319

(57) ABSTRACT

A double-layer window covering and a transverse moving apparatus thereof includes at least an upper elongated support, a lower elongated support, a transverse moving apparatus, a shade lift cord assembly and a transmission assembly. The transverse moving apparatus is installed in the upper elongated support and linked to the lift cord assembly to pull a first shade coupled on the transmission assembly fastened to one side of the upper elongated support so that synchronous movements are formed for the transverse moving apparatus and the first shade. As a result overlap of the first shade and a second shade can be adjusted to alter lighting brightness and darkness according to user's desire.

### FIELD OF THE INVENTION

The present invention relates to a double-layer window covering and a transverse moving apparatus thereof and particularly to a transverse moving apparatus that has a lift cord assembly operable manually to adjust a first shade's position of the double-layer window covering to alter bright and dark lighting conditions.

### BACKGROUND OF THE INVENTION

There are many different types of window coverings on the market such as pleated shades, roman shades and the like. They mainly aim to be installed at doors and windows of houses to block sunshine and serve decorative purpose. When in use to control lighting brightness and darkness the window coverings usually are rolled upwards to receive or block light across a whole swathe. Such a structure creates many problems in practice, notably:

To control light projection through the conventional window coverings the entire panel of a window covering has to be rolled upwards. Adjusting light projection amount to suit user's requirement is difficult. Practicality of the window covering is not desirable.

### SUMMARY OF THE INVENTION

The present invention aims to provide a double-layer window covering and a transverse moving apparatus thereof to solve the problem of the conventional window coverings that is difficult to adjust light projection as desired. The transverse moving apparatus of the invention is installed in an upper elongated support that has a lift cord assembly fastened to a first shade coupled on a transmission assembly located at one side of the upper elongated support such that the first shade can be moved to effectively adjust the overlap condition of the first shade and a second shade. Thereby bright and dark lighting condition can be adjusted as desired.

To achieve the foregoing object the double-layer window covering according to the invention includes an upper elongated support, a lower elongated support, a transverse moving apparatus, a shade lift cord assembly and a transmission assembly. The transverse moving apparatus is installed in the upper elongated support to form a linking relationship with the shade lift cord assembly and transmission assembly. As a result the transverse moving apparatus and the shade lift cord assembly can be operated synchronously to allow the double-layer window covering to adjust the bright and dark lighting condition.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention.

FIG. 2 is an exploded view of the transmission assembly of the invention.

FIG. 3 is a schematic view of the invention showing a second lift cord pulled by the transverse moving apparatus.

FIG. 4 is a front view of the first shade and second shade in an extended condition.

FIG. 5 is a front view of the first shade and second shade in a retracted condition.

FIG. 6 is a schematic view of the invention showing a first lift cord pulled by the transverse moving apparatus.

FIG. 7 is a schematic view of the invention showing the first and second shades being adjusted to decrease bright condition.

FIG. 8 is a schematic view of the invention showing the first and second shades being adjusted to alter dark condition.

FIG. 9 is a front view of an embodiment of the invention showing the transmission assembly installed on another side of the upper elongated support.

FIG. 10 is a front view of the invention showing the transmission assembly with an automatic winding means located at one side thereof.

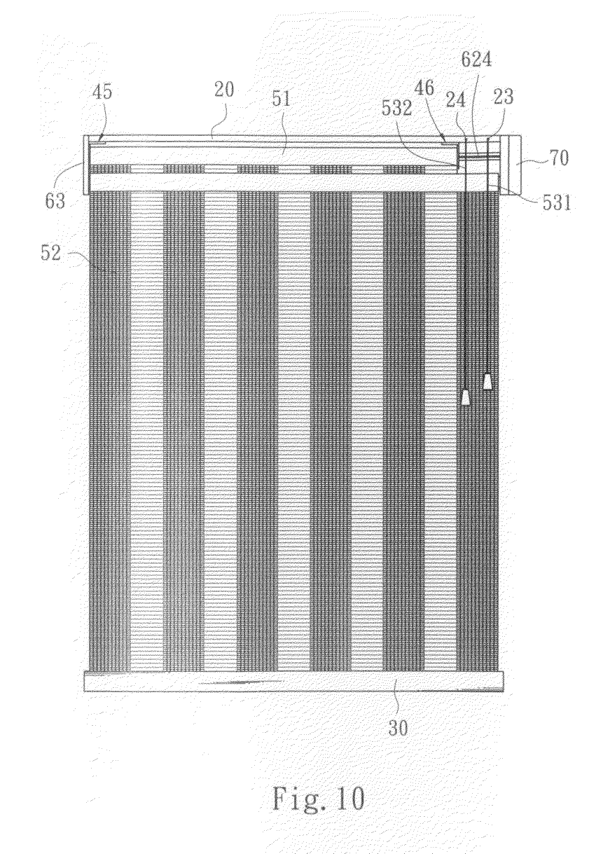

### DETAILED DESCRIPTION OF THE PREFERRED EMBODIMENTS

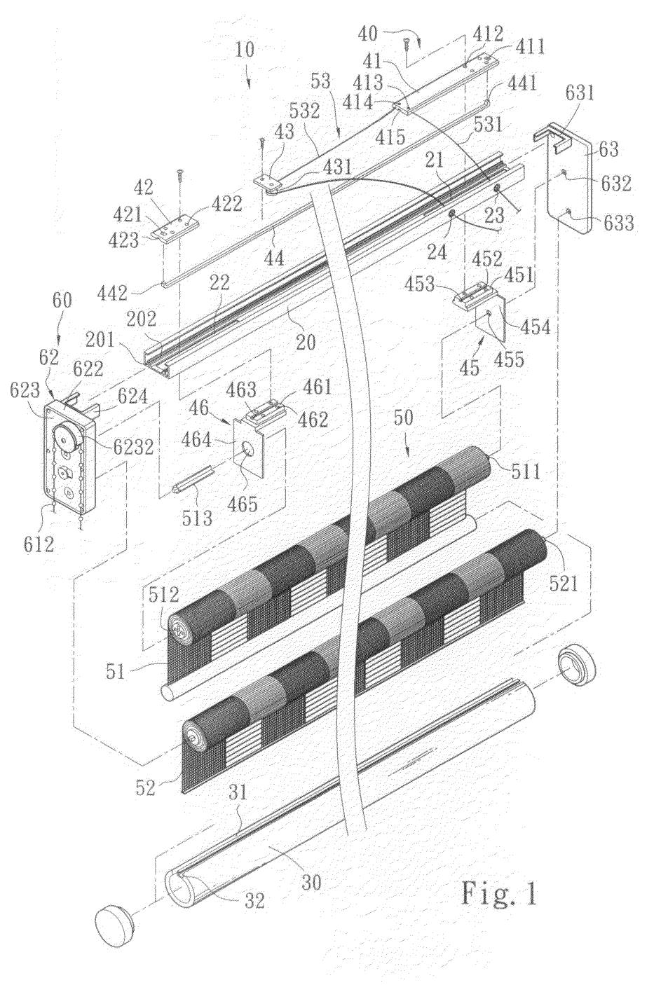

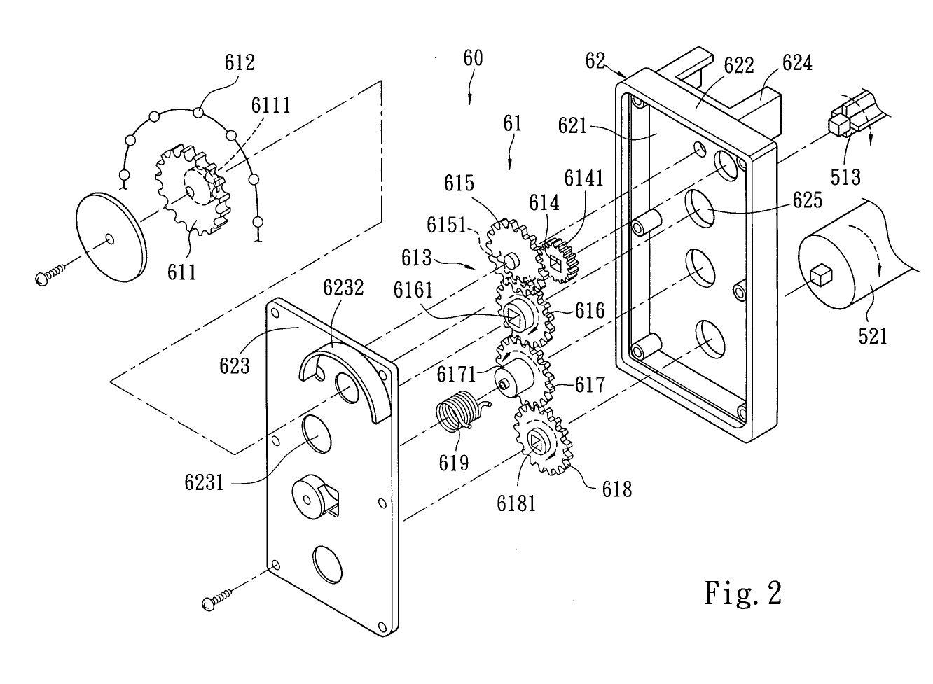

Please refer to FIGS. 1 and 2, the double-layer window covering 10 according to the invention has an upper elongated support 20 with a transverse moving apparatus 40 installed inside. The transverse moving apparatus 40 forms a linking relationship with a shade lift cord assembly 50 and a transmission assembly 60 so that the transverse moving apparatus 40 and the shade lift cord assembly 50 can be operated at the same time to allow the double-layer window covering 10 to adjust lighting brightness and darkness. In an embodiment shown in the drawings the double-layer window covering 10 mainly includes the upper elongated support 20, a lower elongated support 30, transverse moving apparatus 40, shade lift cord assembly 50 and transmission assembly 60.

The upper elongated support 20 is a hollow and elongated rail and has two corresponding fastening troughs 201 formed inside and a guiding trough 202 at each side, and a first aperture 21 and a second aperture 22 at two ends. It has a front end with one side thereof forming a first hole 23 and a second hole 24.

The lower elongated support 30 is a circular rail spaced from the upper elongated support 20 at a lower side. It has a slot 31 at an upper side and a flute 32 at one side of the slot 31.

The transverse moving apparatus 40 includes at least a first plate 41 and a second plate 42, an anchor member 43, a latch rod 44 and a first fastening plate 45 and a second fastening plate 46 that correspond to each other. The first and second plates 41 and 42 are located above the first and second apertures 21 and 22, and can be moved reciprocally at two ends of the guiding trough 202. The first plate 41 has one end with a first coupling hole 411 and a plurality of fastening holes 412 formed thereon, and another end with a first and second holes 413 and 414 formed thereon. It also has a latch trough 415 at the bottom. The second plate 42 has one end with a second coupling hole 421 formed thereon corresponding to the first coupling hole 411 and a plurality of fastening holes 422 formed on the surface, and a second latch trough 423 at the bottom corresponding to the first latch trough 415 of the first plate 41. The anchor member 43 is fastened to the guiding trough 202 of the upper elongated support 20 close to the first plate 41, and has a guiding wheel 431 at a lower side of one end thereof. The latch rod 44 is coupled on the first latch trough 415 and second latch trough 423 at the bottom of the first and second plates 41 and 42, and has two ends formed respectively a latch element 441 and 442 to be inserted in the first coupling hole 411 and second coupling hole 421 of the first and second plates 41 and 42 for anchoring. The first and second fastening plates 45 and 46 have respectively a boss 451 and 461 with a fastening hole 452 and 462 formed thereon. The bosses 451 and 462 run respectively through the first and second apertures 21 and 22 to be fastened to the bottom of the first and second plates 41 and 42 to form grooves 453 and 463 in the center to hold the latch rod 44. At two ends thereof there are upright plates 454 and 464 directing downwards. The first upright plate 454 has a first opening 455. The second upright plate 464 has a second opening 465.

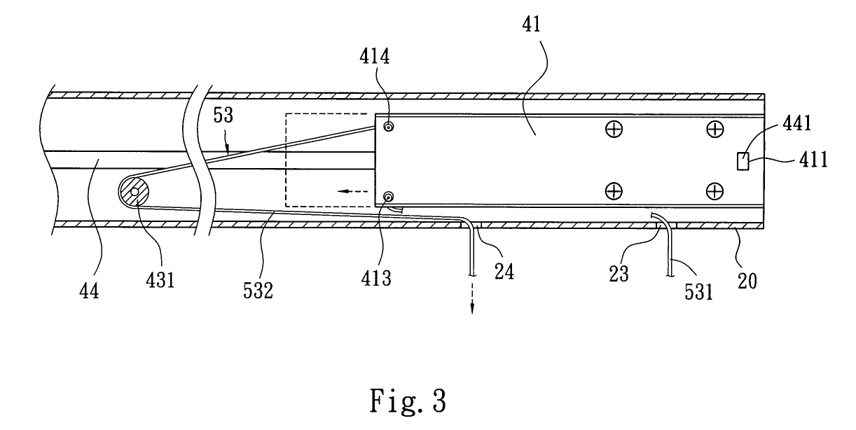

The shade lift cord assembly 50 is located between the upper elongated support 20 and the lower elongated support 30. Referring to FIGS. 1 and 3, it mainly includes a first shade 51, a second shade 52 and a lift cord assembly 53. The first shade 51 has zebra stripes formed thereon as depicted in an embodiment shown in the drawings. The first shade 51 has one end fastened to the bottom of the upper elongated support 20 and coupled with the upright plates 454 and 464 of the first and second fastening plates 45 and 46. Through a first lift cord 531 and a second lift cord 532 of the lift cord assembly 50 the first shade 51 can be moved reciprocally. It has a first axle 511 at one side running through the first opening 455 of the first fastening plate 45 and inserting in a first bore 632, and an axle hole 512 at another side to be coupled with a transmission shaft 513 of a third gear 616. The first shade 51 further has another end coupled with the lower elongated support 30 through the slot 31. The second shade 52 has one end located below the one end of first shade 51, and is coupled with a second bore 633 and a square opening 6181 of a fifth gear 618 through two ends of a second axle 521, while another end thereof is wedged in the flute 32 of the lower elongated support 30. The first lift cord 531 of the lift cord assembly 53 is fastened to the first hole 413 of the first plate 41 and runs through the first hole 23 of the upper elongated support 20. The second lift cord 532 is fastened to the second hole 414 of the first plate 41 and winds around the guiding wheel 431 of the anchor member 43 and runs through the second hole 24 of the upper elongated support 20.

Referring to FIGS. 1 and 2, the transmission assembly 60 includes at least a first coupling cap 62 and a second coupling cap 63 located respectively at two sides of the upper elongated support 20, a control module 61 located in the first coupling cap 62 and a transmission shaft 513 pivotally coupled with the control module 61. The first coupling cap 62 includes a box 622 with a housing compartment 621 formed inside and a lid 623. The box 622 has a first latch member 624 at an upper edge of one side to be latched on one side of the upper elongated support 20. The housing compartment 621 has a plurality of first holes 625. The lid 623 is fastened to the box 622 outside the housing compartment 621 and has second holes 6231 formed thereon corresponding to the first holes 625, and an arched flange 6232 at an upper portion of one side thereof. The second coupling cap 63 has a second latch member 631 at one side corresponding to the first latch member 624 to be latched on another side of the upper elongated support 20, and the first bore 632 which allows one end of the first axle 511 of the first shade 51 to run through after having passed through the first opening 455 of the first fastening plate 45, and the second bore 633 to be coupled with one end of the second axle 521 of the second shade 52. The control module 61 includes a transmission wheel 611 hinged below the arched flange 6232 of the lid 623 and a lift cord chain 612 coupled on the transmission wheel 611, and a gear set 613 located in the housing compartment 621 of the box 622. The gear set 613 includes a first, second, third, fourth and fifth gears 614, 615, 616, 617 and 618 that are engaged with one another to perform transmission. The first gear 614 has one end hinged on the box 622 and a first square opening 6141 in the center to be coupled with a stub shaft 6111 of the transmission wheel 611 hinged on the lid 623. The second gear 615 is engaged with the first gear 614 at one side, and has two ends hinged respectively on the box 622 and lid 623, and one side attached to another gear 6151. The third gear 616 is located below the second gear 615 and engages with the another gear 6151, and has a square opening 6161 in the center to be coupled with the transmission shaft 513 at another end of the first axle 511 of the first shade 51. The fourth gear 617 is located below the third gear 616 and engaged with each other, and has a strut 6171 at one side to couple with an elastic element 619 to provide cushion. The fifth gear 618 is located below the fourth gear 617 and engaged with each other, and has the fifth square opening 6181 in the center to be coupled with another end of the second axle 521 of the second shade 52.

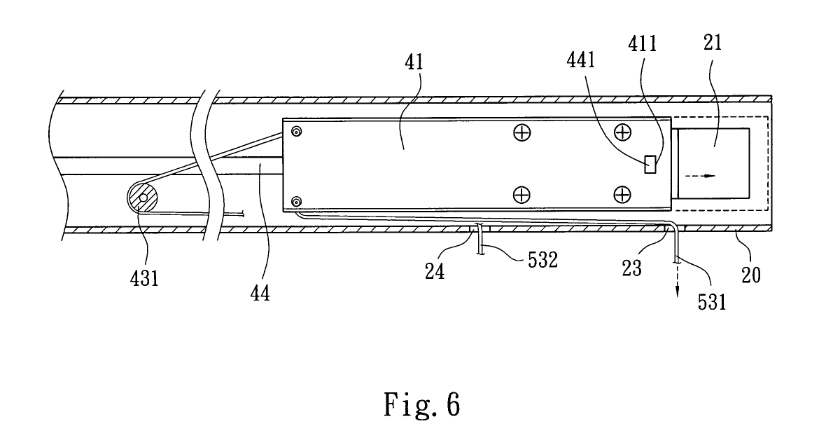

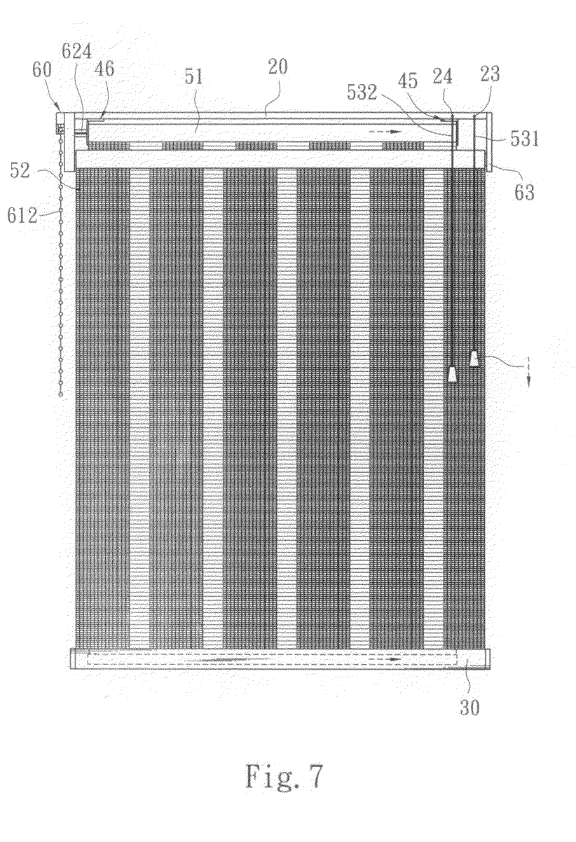

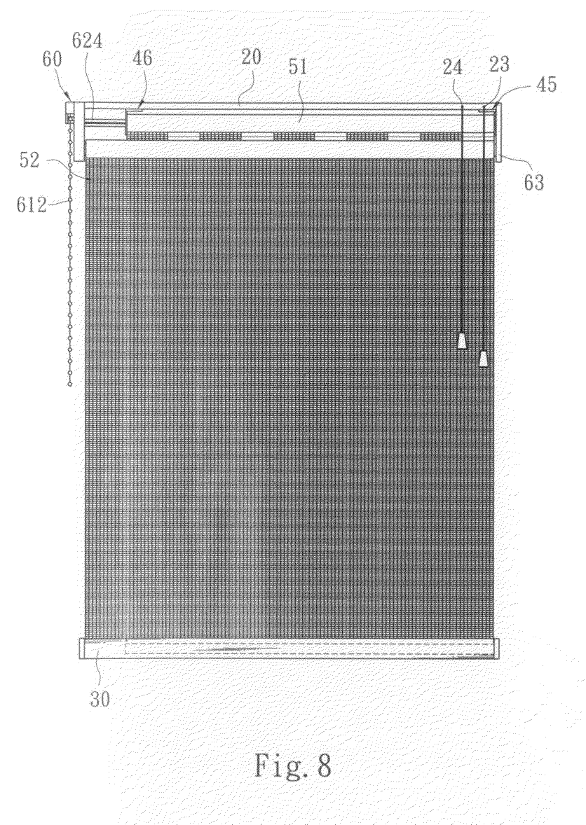

When the double-layer window covering 10 of the invention is in use to extend and retract the first shade 51 and second shade 52, referring to FIGS. 1 and 3, the transverse moving apparatus 40 is installed in the upper elongated support 20, with one side of the first plate 41 fastened to the first lift cord 531 and threaded through the first hole 23. The second lift cord 532 has one end fastened to the first plate 41 and another end wound around the guiding wheel 431 and threaded through the second hole 24 of the upper elongated support 24 so that the first and second plates 41 and 42 can be moved at the same time through the latch rod 44 interposed between them. When the second lift cord 532 is pulled, the first shade 51 fastened below the first and second plates 41 and 42 is moved from an original position overlapped with the second shade 52 in a dark area towards one side so that the dark areas of the first shade 51 and second shade 52 that have the zebra stripes formed thereon have the dark areas overlapped to become a bright area. Referring to FIG. 6, when the first lift cord 531 is pulled, the first shade 51 fastened below the first and second plates 41 and 42 is moved from the bright area against the second shade 52 to another side so that the first shade 51 and second shade 52 can be moved from the maximum bright area to a minimum brightness area or a dark area according to user's desire (referring to FIGS. 7 and 8).

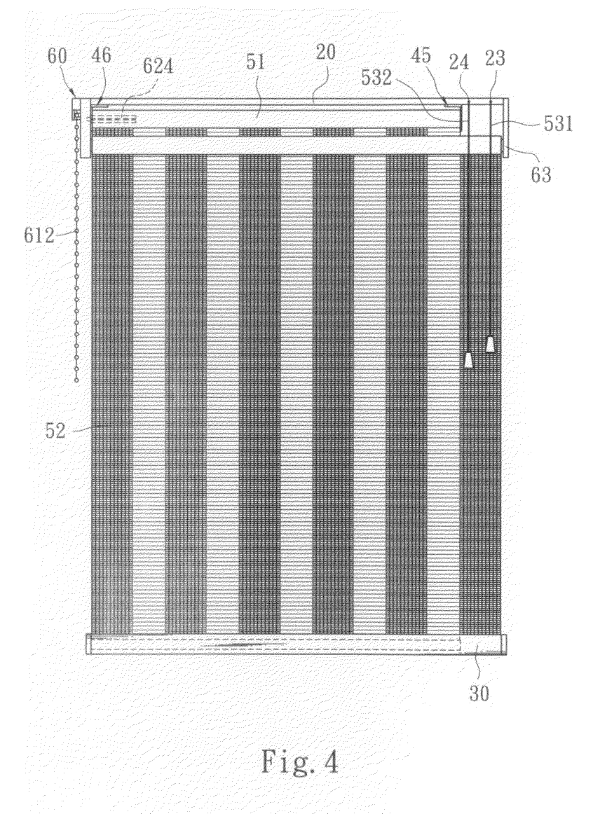

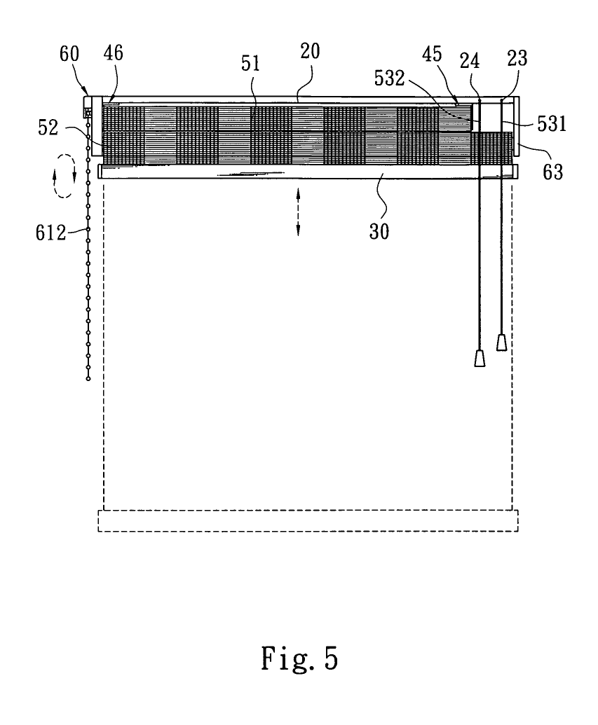

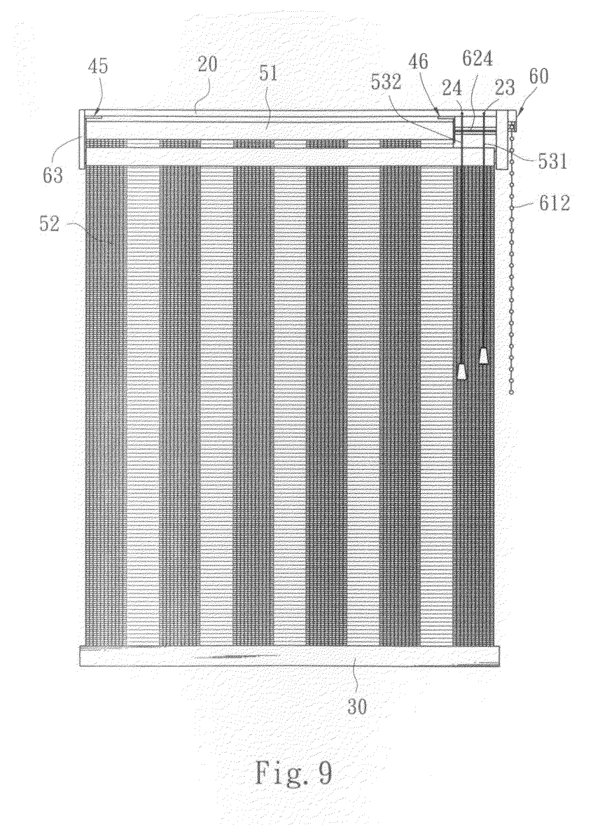

Referring to FIGS. 2 and 4, the control module 61 of the transmission assembly 60 held in the first coupling cap 62 is located at one side of the upper elongated support 20, or another side of the upper elongated support 20 as shown in FIG. 9, or is coupled with an axle (not shown in the drawings) of a speed change means of the transmission assembly 60 to form an automatic winding means 70. To retract the first and second shades 51 and 52, pull the lift cord chain 612 wound on the transmission wheel 611 of the control module 61 below the arched flange 6232, the first gear 614 hinged on one side of the transmission wheel 611 also is driven to drive the engaged third gear 616 and fifth gear 618, hence the coupled first and second shades 51 and 52 are rolled upwards and retracted (referring to FIG. 5), or lowered in an extending condition (referring to FIG. 4). Thus by means of the operation of the control module 61 or automatic winding means 70 set forth above the first and second shades 51 and 52 can be moved as desired to retract and extend the double-layer window covering 10. Operation is smooth and easy.

What is claimed is:

1. A transverse moving apparatus for double-layer window coverings each of which has an upper elongated support, a first shade and a lift cord assembly coupling to the transverse moving apparatus, comprising:
a first plate and a second plate located on the upper elongated support;
an anchor member which is fastened to the upper elongated support and has a guiding wheel located thereon;
a latch rod which is located on the upper elongated support and has two ends coupling respectively on the first plate and the second plate; and
a first fastening plate and a second fastening plate that have respectively a boss located thereon to run through the upper elongated support and be fastened to the first plate and the second plate and an upright plate directing downwards from one end thereof.

2. The transverse moving apparatus of claim 1, wherein the first plate has a plurality of first fastening holes at one end, the second plate having a plurality of second fastening holes at one end thereof, the first and second fastening plates being fastened to the bottom of the first plate and the second plate through the first and second fastening holes.

3. The transverse moving apparatus of claim 1, wherein the double-layer window covering has a second shade, and the first shade and the second shade have zebra stripes formed thereon.

4. The transverse moving apparatus of claim 1, wherein the lift cord assembly has a first lift cord fastened to a first hole formed on the first plate and threaded through the upper elongated support, and a second lift cord fastened to a second hole formed on the first plate and wound around the guiding wheel and threaded through the upper elongated support.

5. The transverse moving apparatus of claim 4, wherein the first shade has one end coupled with the upright plate of the first fastening plate and the second fastening plate and is movable reciprocally through the first lift cord and the second lift cord.

6. A double-layer window covering comprising at least an upper elongated support, a lower elongated support, a transmission assembly, a transverse moving apparatus and a shade lift cord assembly, wherein the transverse moving apparatus includes at least:
a first plate and a second plate located on the upper elongated support;
an anchor member which is fastened to the upper elongated support and has a guiding wheel located thereon;
a latch rod which is located on the upper elongated support and has two ends coupling respectively on the first plate and the second plate; and
a first fastening plate and a second fastening plate that have respectively a boss located thereon to run through the upper elongated support and be fastened to the first plate and the second plate and an upright plate directing downwards from one end thereof.

7. The double-layer window covering of claim 6, wherein the shade lift cord assembly has a first lift cord fastened to the first plate and threaded through the upper elongated support, and a second lift cord fastened to the first plate and wound around the guiding wheel and threaded through the upper elongated support, therefore the first plate, the second plate and the latch rod being movable reciprocally through the first lift cord and the second lift cord.

8. The double-layer window covering of claim 7, wherein the first shade has one end coupled with the upright plate of the first fastening plate and the second fastening plate and is movable reciprocally through the first lift cord and the second lift cord.

9. The double-layer window covering of claim 6, wherein the transmission assembly includes a control module located at one side or another side of the upper elongated support.

10. The double-layer window covering of claim 9, wherein the control module has one side connected to the transmission assembly to form an automatic winding means.
